(19) United States
(12) Patent Application Publication
(10) Pub. No.: US 2024/0117985 A1
(43) Pub. Date: Apr. 11, 2024

(54) ARTIFICIAL INTELLIGENCE AIR-CONDITIONING CONTROL SYSTEM AND METHOD USING INTERPOLATION METHOD

(71) Applicant: Hanon Systems, Daejeon (KR)

(72) Inventors: Wonshick KO, Daejeon (KR); Jeong Hoon LEE, Daejeon (KR); Joong Jae KIM, Daejeon (KR)

(21) Appl. No.: 18/274,812

(22) PCT Filed: Mar. 8, 2022
(86) PCT No.: PCT/KR2022/003244

§ 371 Date: Jul. 28, 2023

(30) Foreign Application Priority Data
Apr. 12, 2021 (KR) 10-2021-0047197

(51) Int. Cl. F24F 11/63

(52) U.S. Cl. CPC F24F 11/63

(57) ABSTRACT

The present invention relates to an artificial intelligence air conditioning control system and method using interpolation. The present invention provides an artificial intelligence air conditioning control system and method using interpolation that is capable of driving an optimal control value by estimating the desired air conditioning target value through interpolation on the output values resulted from training on only minimal air conditioning data.

### TECHNICAL FIELD

The present invention relates to an artificial intelligence air conditioning control system and method using interpolation, and more particularly, to an artificial intelligence air conditioning control system and method using interpolation that is capable of improving the learning time and convergence of the learning algorithm by training with minimal air conditioning control data and performing interpolation on the output control values to quickly estimate the optimal control values for the desired air conditioning setpoints.

### BACKGROUND ART

A vehicle air conditioning system is a device that cools or heats the air and circulates it inside a vehicle during the process of bringing external air into the vehicle cabin or recirculating the air within the cabin to provide cooling or heating. Recently, technologies are being developed to automatically control the air conditioning in order to enhance the driver's focus and concentration while driving.

Although there is a development of technologies, particularly using artificial intelligence techniques, to output control values that track the desired air conditioning performance factor based on the current state information of the air conditioning performance factors under various environmental conditions, the wide range of environmental conditions, ranging from below −10 degrees Celsius to above 30 degrees Celsius, and the range of target air conditioning performance factors inputted from the driver (or passengers) with increments as small as 0.5 degrees Celsius depending on the vehicle's settings, pose challenges in generating training data for all possible scenarios as long as the climate condition does not maintains the average temperature throughout the year, resulting in lengthy and costly preparation and processing time for training despite achieving high accuracy in the output values (tracking values/control values).

Regarding this, Korean Patent Publication No. 10-2019-0112681 (Apparatus and method for controlling air conditioning of a vehicle) discloses a method of operating a vehicle air conditioning control device by executing artificial intelligence algorithms and machine learning algorithms.

### DOCUMENTS OF RELATED ART

### Patent Document

Korean Patent Publication No. 10-2019-0112681 (2019.10.07.)

### DISCLOSURE

### Technical Problem

The present invention has been conceived to address the drawbacks of the above-described conventional technologies, and it is an object of the present invention to provide an artificial intelligence air conditioning control system and method using interpolation that is capable of improving the learning time and convergence of the learning algorithm by training with minimal air conditioning control data and performing interpolation on the output control values to quickly estimate the optimal control values for the desired air conditioning setpoints.

### Technical Solution

In order to accomplish the above object, an artificial intelligence air conditioning control system using interpolation according to the present invention includes a first input unit 100 acquiring performance factor target information for air conditioning control through external input, a second input unit 200 acquiring performance factor current stat information from a pre-linked air conditioning system, a control unit including a plurality of artificial intelligence learning model units 310 configured with different external environmental conditions and outputting initial control values allowing the performance factor current state information from the second input unit 200 to track the performance factor target information from the first input unit 100 based on the configured external environmental conditions, and an interpolation unit 400 receiving the initial control values generated by the artificial intelligence learning model units 310 from the control unit to generate an interpolation function and generating a final control value by applying a current external environmental condition input in real-time to the interpolation function, wherein the interpolation unit 400 preferably transmits the final control value to the air conditioning system for artificial intelligence air conditioning.

In addition, the control unit preferably further includes a learning processing unit 320 training the performance factor target information and performance factor current state information collected based on external environmental conditions of different predetermined temperatures in association with pre-executed air conditioning control using a predetermined AI algorithm, generating external environment condition-specific artificial intelligence learning models, and transmitting the interfacial intelligence learning models to the artificial intelligence learning model unit 310.

In addition, the learning processing unit 320 preferably sets intervals for the collected performance factor target information associated with pre-executed air conditioning control within predetermined ranges and establishes a midpoint or a specific value for each interval as representative target information, sets intervals for the collected performance factor current state information associated with pre-executed air conditioning control within predetermined ranges and establishes a midpoint or a specific value for each interval as the representative state information, generates training data by matching the set representative target information and representative state information and control values corresponding to the representative target information and state information, and performs the training process of the training data using the predetermined AI algorithm, based on different predetermined temperature values of the external environmental conditions.

In addition, the artificial intelligence learning model unit 310 preferably receives the external environmental conditions of different predetermined temperatures as reference learning models based on the training processing result from the learning processing unit 320 and outputs the initial control values allowing for the performance factor current state information from the second input unit 200 to track the performance factor target information from the first input unit 100 by reflecting the external environmental conditions specific to each learning model.

In addition, the artificial intelligence learning model unit 310 preferably selects an interval corresponding to the performance factor target information from the first input unit 10 and an interval corresponding to the performance factor current state information from the second input unit 200 by reflecting the ranges set by the learning processing unit 320, and outputs the initial control values by applying specific result information to each learning model.

In addition, the interpolation unit 400 preferably generates an interpolation function for the initial control values using a predetermined interpolation algorithm and applies a current external environmental condition input in real-time to the interpolation function to generate the final control value.

In order to accomplish the above object, an artificial intelligence air conditioning control method using interpolation according to the present invention includes a target input step S100 acquiring, by a first input unit, performance factor target information for air conditioning control through external input, a state input step S200 acquiring, by a second input unit, performance factor current stat information from a pre-linked air conditioning system, an AI control step S300 outputting initial control values allowing the performance factor current state information to track the performance factor target information by inputting the performance factor target information acquired at the target input step S100 and the performance factor current state information acquired at the state input step S200, a final control step S400 generating, by an interpolation unit, a final control value by applying a current external environmental condition input in real-time to an interpolation function generated using the initial control values from the AI control step S300, and an air conditioning control step S500 performing, by the interpolation unit, artificial intelligence air conditioning by transmitting the final control value generated at the final control step S400 to the air conditioning system.

In addition, the AI control step S300 preferably further includes a learning processing step S310 generating external environment condition-specific artificial intelligence learning models by training the performance factor target information and performance factor current state information matching the performance factor target information collected based on external environmental conditions of different predetermined temperatures in association with pre-executed air conditioning control using a predetermined AI algorithm.

In addition, the learning processing step S310 preferably includes setting intervals for the collected performance factor target information associated with pre-executed air conditioning control within predetermined ranges and establishing a midpoint or a specific value for each interval as representative target information; setting intervals for the collected performance factor current state information associated with pre-executed air conditioning control within predetermined ranges and establishing a midpoint or a specific value for each interval as the representative state information; generating training data by matching the set representative target information and representative state information and control values corresponding to the representative target information and state information; and performing the training process of the training data using the predetermined AI algorithm, based on different predetermined temperature values of the external environmental conditions.

In addition, the AI control step S300 preferably includes determining an interval corresponding to the performance factor target information acquired at the target input step S100 and an interval corresponding to the performance factor current state information acquired at the state input step S200 by reflecting the ranges set at the learning processing step S310, and outputting the initial control values by applying specific result information to each learning model.

### Advantageous Effects

The artificial intelligence air conditioning control system and method using interpolation according to the present invention is advantageous in terms of improving the learning time and convergence of the learning algorithm by training with minimal air conditioning control data and performing interpolation on the output control values to quickly estimate the optimal control values for the desired air conditioning setpoints.

In detail, the artificial intelligence air conditioning control system and method using interpolation according to an embodiment of the invention is advantageous in terms of addressing the drawbacks associated with artificial intelligence learning by specifying multiple predetermined temperature levels as external environmental conditions that a vehicle may encounter, matching the air conditioning performance factor current state information and the air conditioning performance factor target information input by the passengers at each specific temperature level, generating training data consisting of the corresponding control values, and training on only a subset of the environmental conditions.

Through this, the artificial intelligence air conditioning control system and method using interpolation according to an embodiment of the present invention offers the advantage of addressing the drawbacks associated with artificial intelligence learning, such as the requirement for large amounts of training data, data collection for training, and the time it takes to process the collected data, while still retaining the benefits of accuracy in the results achieved through artificial intelligence learning.

### BRIEF DESCRIPTION OF THE DRAWINGS

FIG. 1 is a diagram illustrating a configuration of an artificial intelligence air conditioning control system using interpolation according to an embodiment of the present invention;

FIG. 2 is a diagram illustrating an example of setting training data in an artificial intelligence air conditioning control system using interpolation according to an embodiment of the present invention;

FIG. 3 is a diagram illustrating an example of generating a final control value by applying interpolation to initial control values in an artificial intelligence air conditioning control system using interpolation according to an embodiment of the present invention; and

FIG. 4 is a flowchart illustrating an artificial intelligence air conditioning control method using interpolation according to an embodiment of the present invention.

### MODE FOR INVENTION

Hereinafter, a description is made of the artificial intelligence air conditioning control system and method using interpolation configured as above according to the present invention in detail with reference to accompanying drawings.

In addition, the term “system” refers to a collection of components, devices, mechanisms, or means that are organized and interact in a regular manner to perform the required functions.

The artificial intelligence air conditioning control system and method using interpolation according to an embodiment of the invention is used to quickly and comfortably control the temperature inside the vehicle by applying the current air conditioning performance factor state information and the air conditioning performance factor target information input from the driver (or passengers) to the learning model generated through the learning processing of the training data using artificial intelligence techniques and outputting optimal control values allowing for the current performance factor state information to track the performance factor target information.

Typically, when utilizing artificial intelligence techniques, it is natural to expect that the accuracy of the results improves as the learning model is trained on a larger amount of training data, and thus, to obtain the optimal control values, it is necessary to generate as many control values as possible by incorporating the current air conditioning performance factor state information for all environmental conditions and the air conditioning performance factor target information obtained from the driver (or passengers) for all feasible conditions.

However, in the case of vehicles, it is not a special enclosed space where the internal temperature needs to be maintained or demanded sensitively, and most passengers also do not react sensitively to temperature differences of 1 to 2 degrees. That is, passengers primarily demand air conditioning control that brings relatively cool air into the vehicle compared to the external air, making the air inside the vehicle comfortable, and the requirement for air conditioning control that demands air at a specific temperature 10 degrees lower than the external air to make the air inside the vehicle comfortable is clearly a very specific and limited scenario.

Taking these factors into consideration, the artificial intelligence air conditioning control system and method using interpolation according to an embodiment of the present invention addresses the drawbacks associated with artificial intelligence learning by specifying multiple predetermined temperature levels as external environmental conditions that a vehicle may encounter, generating training data from the air conditioning performance factor current state information and the air conditioning performance factor target information input by the passengers and the corresponding control values that match at each specific temperature, and training only a part of the environmental conditions.

Furthermore, the artificial intelligence air conditioning control system and method using interpolation according to an embodiment of the present invention actively addresses the drawbacks associated with artificial intelligence learning by defining intervals for specific ranges of the air conditioning performance factor current state information and the air conditioning performance factor target information, setting representative information for each interval, and generating training data using the representative information and corresponding control values, considering the potential fine-grained nature of these factors based on the production options of the vehicle.

However, as only a minimal amount of training data is used for learning, when external environmental conditions that do not correspond to the training data or information that deviates from the representative information are input to the learning model, in other words, in unlearned areas, it may not be able to produce accurate output values.

To address this issue, the artificial intelligence air conditioning control system and method using interpolation according to an embodiment of the present invention can generate an interpolation function for the initial control values output from the learning model that has learned information about each external environmental condition using interpolation, and use the generated interpolation function to infer and derive the final control values.

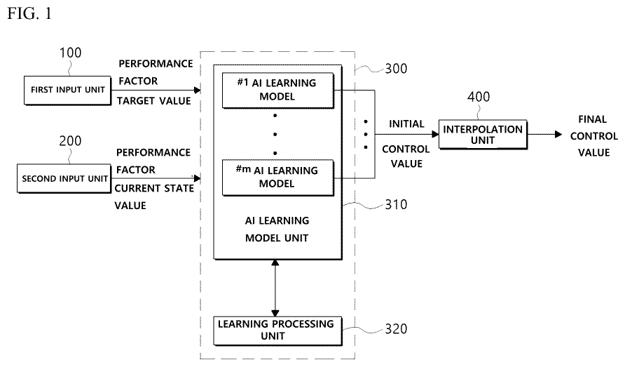

FIG. 1 is a diagram illustrating a configuration of an artificial intelligence air conditioning control system using interpolation according to an embodiment of the present invention, and a description is made of the artificial intelligence air conditioning control system using interpolation according to an embodiment of the present invention with reference to FIG. 1 in detail.

As shown in FIG. 1, the artificial intelligence air conditioning control system using interpolation according to an embodiment of the present invention is preferably configured to include a first input unit 100, a second input unit 200, a control unit 300, and an interpolation unit 400, and each of these components may be implemented as a single processing means or included within respective processing means to perform respective operations.

In more detail, it is preferable for the first input unit 100 to acquire the performance factor target information for air conditioning control based on the desired air conditioning state information selected through the external input from a vehicle passenger.

For example, when the passenger inputs a specific temperature corresponding to cooling, it is preferable for the performance factor target information for air conditioning control based on this to be the specific temperature of the evaporator.

It is preferable for the second input unit 200 to acquire the performance factor current state information from the air conditioning system (air conditioning device) that is pre-linked, in other words, the air conditioning system to which the artificial intelligence air conditioning control system using interpolation according to an embodiment of the invention is to be applied. In addition to the above example, it is preferable to acquire the current temperature of the evaporator.

It is preferable for the control unit 300 to set the control value for controlling the air conditioning state using the performance factor target information and the performance factor current state information that are input, and for this purpose, it is preferable for the control unit 300 to include an AI learning model unit 310 including a plurality of AI learning models and a learning processing unit 320, as shown in FIG. 1.

It is preferable for the AI learning model unit 310 to apply the performance factor current state information from the second input unit 200 and the performance factor target information from the first input unit 100 to multiple AI learning models trained with different external environmental conditions, in order to output multiple initial control values allowing the performance factor current state information to track the performance factor target information.

That is, the AI learning model unit 310 disregards the current external environmental conditions and instead inputs the performance factor current state information and the performance factor target information to multiple AI learning models trained with different external environmental conditions, and outputs multiple initial control values allowing the performance factor current state information to track the performance factor target information.

The learning processing unit 320 controls the training process for each different external environmental condition as described above, and in more detail, it is preferable for the learning processing unit 320 to use predetermined AI algorithm to train using pre-collected performance factor target information, performance factor current state information, and the control values (which aim to converge the difference between the performance factor current state information and the performance factor target information to zero) obtained based on different predetermined external environmental conditions, and generate and transmit AI learning models for each external environmental condition to the AI learning model unit 310.

Here, in order to avoid potential issues with algorithm convergence in the case of using all control values of the air conditioning performance factor, it is preferable for the learning processing unit 320 to select training target data (representative information) within the divided ranges divided at regular intervals and perform training by setting only the selected representative information as the training data.

Certainly, for the ranges that are not covered by the training data, it is possible to derive control values by tracking the surrounding area (coverage area) of the representative information through interpolation using the interpolation unit 400 in the future. The operation of the interpolation unit 400 is described in detail later.

By selecting the learning target data (representative information) within the ranges divided at regular intervals through the learning processing unit 320 and setting only the selected representative information as the learning data, it is possible to shorten the learning period and improve the convergence of the artificial intelligence learning algorithm.

Here, it is preferable to define the external environmental conditions corresponding to the specific temperature based on the range of ambient temperatures that the vehicle may be exposed to, using predetermined temperature intervals such as −10° C., 0° C., 10° C., and 20° C. as reference points, collect the performance factor target information, performance factor current state information, and the control values obtained from pre-executed air conditioning control at these specific ambient temperatures, and perform training processing based on the collected information.

Although it may be thought that the control value for a 10-degree difference between the performance factor target information and the performance factor current state information is output regardless of the external environmental conditions, it is preferable to perform training processing based on each distinct external environmental condition as a reference because the air conditioning performance factor control value to control the difference of 10 degrees at an external temperature of −10 degrees and the air conditioning performance factor control value to control the difference of 10 degrees at an external temperature of 20 degrees will naturally differ due to the operating conditions of the vehicle.

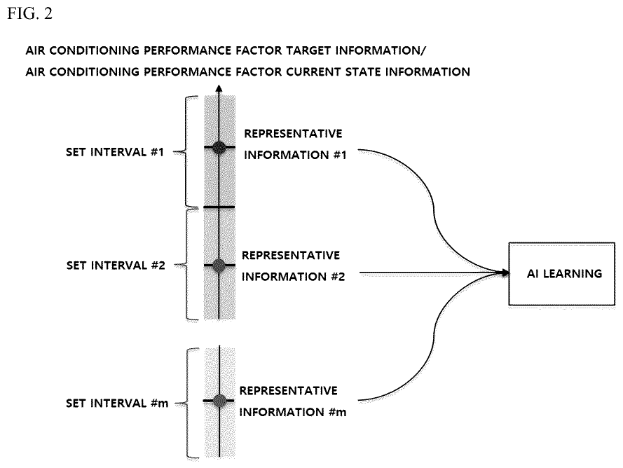

In addition, it is preferable for the learning processing unit 320 to set intervals for the predetermined range of the collected performance factor target information, as shown in FIG. 2, for the purpose of establishing the representative information, set the midpoint or a specific value of each interval as the representative target information, sets intervals within the predetermined range for current state information collected in association with the pre-executed air conditioning control, and establish the midpoint or specific value of each interval as representative state information.

In this case, it is preferable to set the predetermined ranges for the performance factor target information and the performance factor current state information based on the initial applied air conditioning control range of the vehicle, but is not limited thereto.

However, setting the ranges too narrowly may include the convergence issues of the AI learning algorithm, which is the main issue to be addressed by the present invention, while setting them too wide may result in lower accuracy or higher computational complexity in the process of tracking and deriving control values through the interpolation unit 400 in the future; therefore, it is most preferable to appropriately set the ranges based on the initial applied air conditioning control range of the vehicle.

Through this, the learning processing unit 320 generates training data by setting the representative target information and representative state information and the control values corresponding to the representative target information and representative state information (values that converge the difference between the representative state information and the representative target information to zero), and performs training processing of the generated training data using a pre-defined AI algorithm based on the predetermined ranges of the external environmental conditions.

Accordingly, it is preferable for the AI learning model unit 310 to receive multiple learning models based on different predetermined ranges of external environmental conditions according to the training processing results from the learning processing unit 320. Afterward, it is preferable for the AI learning model unit 310 to receive the performance factor target information from the first input unit 100 and the performance factor current state information from the second input unit 200 and output learning model-specific control values allowing the performance factor current state information from the second input unit 200 to track the performance factor target information from the first input unit 100.

That is, the AI learning model unit 310 receives the control values (initial control values) based on the predetermined external environmental conditions, without considering the external environmental conditions.

Since the learning processing unit 320 learns the set representative target information and representative state information and the control values corresponding to the set representative target information and representative state information as described above, when information beyond the learning range is input through the first input unit 100 and the second input unit 200, it may not be able to output any control value or may output an inaccurate control value.

Therefore, it is preferable for the AI learning model unit 310 to enhance the accuracy of the output values by performing preprocessing on the performance factor target information and performance factor current state information before inputting them into multiple learning models.

In detail, it is preferable for the AI learning model unit 310 to determine an interval for the performance factor target information from the first input unit 100 and an interval for the performance factor current state information from the second input unit 200, reflecting the predetermined ranges of the performance factor target information and the performance factor current state information set by the learning processing unit 320.

For example, when the performance factor target information is 8 degrees and the predetermined range of the performance factor target information is set from −20 degrees with a step size of 10 degrees, it is preferable to determine the interval corresponding to the performance factor target information as the range of 1 to 10 degrees.

As this, it is preferable for the AI learning model unit 310 to output for each interval by applying representative information of each interval to the respective learning models using the interval information corresponding to the specific performance factor target information and the interval information corresponding to the performance factor current state information.

That is, in the above example, when the representative target information for the interval of 1 to 10 degrees, which corresponds to the performance factor target information, is 5 degrees, it is preferable for the AI learning model unit 310 to set 5 degrees as the input data instead of 8 degrees that was input as the performance factor target information. There is a difference of 3 degrees between the actual input value and the representative value in this example given with intervals of 10 degrees for the purpose of easier explanation; however, depending on the extent of interval setting, it is possible to receive initial control values generated based on the representative information for temperature ranges that passengers may not perceive.

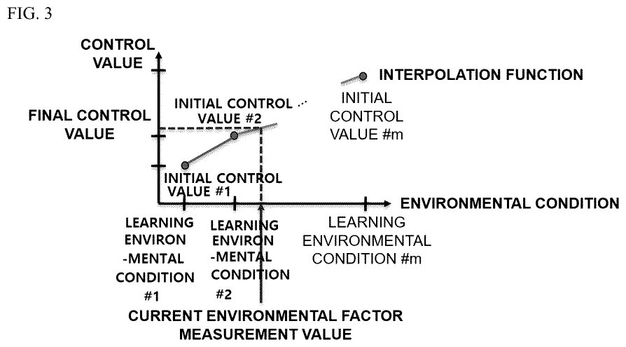

It is preferable for the interpolation unit 400 to receive the initial control values from the AI learning models in the control unit 300 and generate interpolation functions as shown in FIG. 3.

It is preferable for the interpolation unit 400 to use polynomial interpolation method to generate the interpolation functions and select the degree of the polynomial based on the number of external environmental conditions (m) and the control performance associated with the polynomial degree; although a linear interpolation method, which connects two adjacent points with a straight line, is used as the polynomial interpolation method, this is merely an embodiment of the present invention.

It is preferable for the interpolation unit 400 to apply the current external environmental conditions, which are input in real-time, to the interpolation functions and generate the final control values.

Additionally, it is preferable for the interpolation unit 400 to transmit the generated final control values to the air conditioning system for AI-based air conditioning control.

By collecting the performance factor target information and performance factor current state information for pre-executed air conditioning control at temperatures of −10 degrees, 0 degrees, 10 degrees, and 20 degrees as reference points for external environmental conditions, and the control values generated based on the performance factor target information and performance factor current state information, and by performing learning processing, the interpolation unit may derive the control value corresponding to an external temperature of 7 degrees, which is input as the current external environmental condition in real-time, by interpolating between the control values generated by the learning models at 0 degrees and 10 degrees.

Through this, the AI-based air conditioning control system using the interpolation method according to the disclosed embodiment of the present invention is capable of mitigating the drawbacks of collecting a lot of training data and the long training processing time while still retaining the accuracy inherent in AI learning.

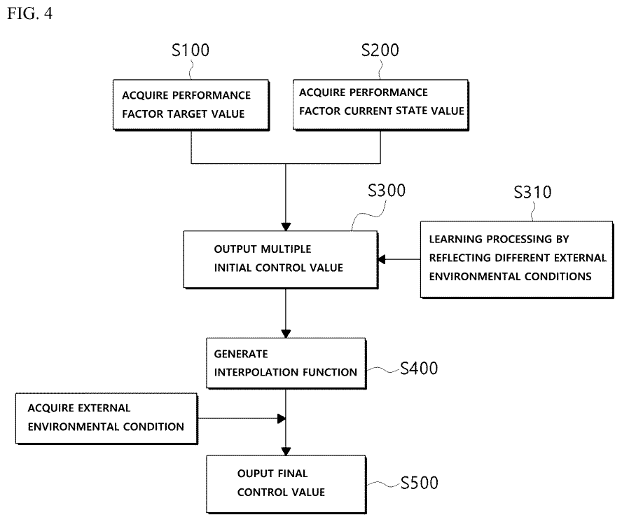

FIG. 4 is a flowchart illustrating an artificial intelligence air conditioning control method using interpolation according to an embodiment of the present invention, and a description is made of the artificial intelligence air conditioning control method using interpolation according to an embodiment of the present invention with reference to FIG. 4 in detail.

As shown in FIG. 4, it is preferable for the AI-based air conditioning control method using interpolation according to an embodiment of the present invention to include a target input step S100, a state input step S200, an AI control step S300, a final control step S400, and an air conditioning control step S500.

The first input unit 100 acquires the performance factor target information for air conditioning control based on the desired air conditioning state information selected through the external input from a vehicle passenger at the first input step S100.

At the state input step S200, the second input unit 200 acquires the current state information of the performance factors from the pre-linked air conditioning system.

At the AI control step S300, the AI learning model unit 310 outputs initial control values for each AI learning model by inputting the performance factor target information from the target input step S100 and the performance factor current state information from the state input step S200 to the multiple AI learning models, aiming for the performance factor current state information to track the performance factor target information.

In more detail, at the AI control step S300, without considering the current external environmental conditions, the performance factor current state information and the performance factor target information are input to the multiple AI learning models trained with different external environmental conditions to output multiple initial control values aiming for the performance factor current state information to track the corresponding performance factor target information.

It is preferable for the multiple AI learning models to be generated through the training processing step S310.

At the training processing step S310, the learning processing unit 320 uses predetermined AI algorithm to train and generate the AI learning models for each external environmental condition using the performance factor target information and performance factor current state information pre-collected based on different predetermined external environmental conditions and control values corresponding to the performance factor target information and performance factor current state information (to converge the difference between the performance factor current state information and the performance factor target information to zero).

Here, in order to avoid potential issues with algorithm convergence in the case of using all control values over entire range of the air conditioning performance factor as training data, it is preferable to select representative training target data (representative information) within the ranges divided at regular intervals and perform training by setting only the selected representative information as the training data.

Certainly, for the ranges that are not covered by the training data, it is possible to derive control values by tracking the surrounding area (coverage area) of the representative information through interpolation using the final control step S400 in the future.

Here, it is preferable to define the external environmental conditions corresponding to the specific temperature based on the range of ambient temperatures that the vehicle may be exposed to, using predetermined temperature intervals such as −10° C., 0° C., 10° C., and 20° C. as reference points, collect the performance factor target information, performance factor current state information, and the control values obtained from pre-performed air conditioning control at these specific ambient temperatures, and perform training processing based on the collected information.

Although it may be thought that the control value for a 10-degree difference between the performance factor target information and the performance factor current state information is output regardless of the external environmental conditions, it is preferable to perform training processing based on each distinct external environmental condition as a reference because the air conditioning performance factor control value to control the difference of 10 degrees at an external temperature of −10 degrees and the air conditioning performance factor control value to control the difference of 10 degrees at an external temperature of 20 degrees will naturally differ due to the operating conditions of the vehicle.

Furthermore, by selecting representative training target data (representative information) within the ranges divided at regular intervals and performing training by setting only the selected representative information as the training data at the training processing step S310, it is possible to shorten the learning period of the AI learning algorithm and improve its convergence.

For this purpose, it is preferable, at the learning processing step S310, to set intervals for the predetermined range of the collected performance factor target information for the purpose of establishing the representative information, set the midpoint or a specific value of each interval as the representative target information, set intervals within the predetermined range for current state information collected in association with the pre-performed air conditioning control, and establish the midpoint or specific value of each interval as representative state information.

In this case, it is preferable to set the predetermined ranges for the performance factor target information and the performance factor current state information based on the initial applied air conditioning control range of the vehicle, but is not limited thereto.

However, setting the ranges too narrowly may include the convergence issues of the AI learning algorithm, which is the main issue to be addressed by the present invention, while setting them too wide may result in lower accuracy or higher computational complexity in the process of tracking and deriving control values through the interpolation step S400 in the future; therefore, it is most preferable to appropriately set the ranges based on the initial applied air conditioning control range of the vehicle.

Through this, at the learning processing step S310, training data is generated by matching the set representative target information and representative state information and the control values corresponding to the representative target information and representative state information (values that converge the difference between the representative state information and the representative target information to zero), and the training processing of the generated training data is performed using a pre-defined AI algorithm based on the predetermined ranges of the external environmental conditions.

In this way, at the AI control step S300, the performance factor target information from the target input step S100 and the performance factor current state information from the state input step S200 are input using the multiple AI learning models generated at the learning processing step S310 for different predetermined external environmental conditions to output learning model-specific control values that allow the performance factor current state information from the state input step S200 to track the performance factor target information from the target input step S100. That is, it is preferable for the initial control values generated at the AI control step S300 to be based on a predetermined external environmental condition, without considering the current external environmental conditions.

In this case, when the performance factor target information from the target input step S100 and the performance factor current state information from the state input step S200 are input at the AI control step S300 fall outside the range determined by training the representative target information and state information and the control values corresponding to the representative target information and state information that are set at the learning processing step S310, it may not be able to output any control value or may output an inaccurate control value.

Therefore, it is preferable, at the AI control step S300, to perform pre-processing of the performance factor target information from the target input step S100 and performance factor current state information the state input step S200 before inputting them into the multiple learning models in order to improve the accuracy of the output values.

In detail, it is preferable, at the AI control step S300, to determine a specific interval for the performance factor target information from the target input step S100 and a specific interval for the performance factor current state information from the state input step S200, by reflecting the predetermined ranges of the performance factor target information and performance factor current state information that are set at the learning processing step S310.

As this, it is preferable to output the initial control values for each learning model by applying representative information of each interval to the respective learning models using the interval information corresponding to the specific performance factor target information and the interval information corresponding to the performance factor current state information.

At the final control step S400, the interpolation unit 400 generates an interpolation function using the initial control values generated at the AI control step S300 and then generates the final control values by applying the current external environmental conditions input to the interpolation function in real-time.

For example, by collecting the performance factor target information and performance factor current state information for pre-executed air conditioning control at temperatures of −10 degrees, 0 degrees, 10 degrees, and 20 degrees as reference points for external environmental conditions, and the control values generated based on the performance factor target information and performance factor current state information, and performing learning processing, it is possible, at the final control step S400, to derive the control value corresponding to an external temperature of 7 degrees, which is input as the current external environmental condition in real-time, by interpolating between the control values generated by the learning models at 0 degrees and 10 degrees.

At the air conditioning control step S500, it is preferable for the interpolation unit 400 to transmit the final control values generated at the final control step S400 to the air conditioning system, allowing the AI-based air conditioning control to take place.

The present invention is not limited to the above-described embodiments and has a wide range of applications, and it will be understood by those skilled in the art that various modifications can be made within the scope of the claims without departing from the essence of the present invention.

### DESCRIPTION OF REFERENCE NUMERALS

100: first input unit
200: second input unit
300: control unit
310: AI learning model unit
320: learning processing unit
400: interpolation unit

What is claimed is:

1. An artificial intelligence air conditioning control system using interpolation, the system comprising:
a first input unit 100 acquiring performance factor target information for air conditioning control through external input;
a second input unit 200 acquiring performance factor current state information from a pre-linked air conditioning system;
a control unit 300 comprising a plurality of artificial intelligence learning model units 310 configured with different external environmental conditions and outputting initial control values allowing the performance factor current state information from the second input unit 200 to track the performance factor target information from the first input unit 100 based on the configured external environmental conditions; and
an interpolation unit 400 receiving the initial control values generated by the artificial intelligence learning model units 310 from the control unit 300 to generate an interpolation function and generating a final control value by applying a current external environmental condition input in real-time to the interpolation function,
wherein the interpolation unit 400 transmits the final control value to the air conditioning system for artificial intelligence air conditioning.

2. The artificial intelligence air conditioning control system using interpolation of claim 1, wherein the control unit 300 further comprises a learning processing unit 320 training the performance factor target information and performance factor current state information collected based on external environmental conditions of different predetermined temperatures in association with pre-executed air conditioning control using a predetermined AI algorithm, generating external environment condition-specific artificial intelligence learning models, and transmitting the interfacial intelligence learning models to the artificial intelligence learning model unit 310.

3. The artificial intelligence air conditioning control system using interpolation of claim 2, wherein the learning processing unit 320 sets intervals for the collected performance factor target information associated with pre-executed air conditioning control within predetermined ranges and establishes a midpoint or a specific value for each interval as representative target information, sets intervals for the collected performance factor current state information associated with pre-executed air conditioning control within predetermined ranges and establishes a midpoint or a specific value for each interval as the representative state information, generates training data by matching the set representative target information and representative state information and control values corresponding to the representative target information and state information, and performs the training process of the training data using the predetermined AI algorithm, based on different predetermined temperature values of the external environmental conditions.

4. The artificial intelligence air conditioning control system using interpolation of claim 3, wherein the artificial intelligence learning model unit 310 receives the external environmental conditions of different predetermined temperatures as reference learning models based on the training processing result from the learning processing unit 320 and outputs the initial control values allowing for the performance factor current state information from the second input unit 200 to track the performance factor target information form the first input unit 100 by reflecting the external environmental conditions specific to each learning model.

5. The artificial intelligence air conditioning control system using interpolation of claim 4, wherein the artificial intelligence learning model unit 310 selects an interval corresponding to the performance factor target information from the first input unit 100 and an interval corresponding to the performance factor current state information from the second input unit 200 by reflecting the ranges set by the learning processing unit 320, and outputs the initial control values by applying specific result information to each learning model.

6. The artificial intelligence air conditioning control system using interpolation of claim 5, wherein the interpolation unit 400 generates an interpolation function for the initial control values using a predetermined interpolation algorithm and applies a current external environmental condition input in real-time to the interpolation function to generate the final control value.

7. An artificial intelligence air conditioning control method using interpolation, the method comprising:
a target input step S100 acquiring, by a first input unit, performance factor target information for air conditioning control through external input; a state input step S200 acquiring, by a second input unit, performance factor current stat information from a pre-linked air conditioning system; an AI control step S300 outputting initial control values allowing the performance factor current state information to track the performance factor target information by inputting the performance factor target information acquired at the target input step S100 and the performance factor current state information acquired at the state input step S200; a final control step S400 generating, by an interpolation unit, a final control value by applying a current external environmental condition input in real-time to an interpolation function generated using the initial control values from the AI control step S300; and
an air conditioning control step S500 performing, by the interpolation unit, artificial intelligence air conditioning by transmitting the final control value generated at the final control step S400 to the air conditioning system.

8. The artificial intelligence air conditioning control method using interpolation of claim 7, wherein the AI control step S300 further comprises a learning processing step S310 generating external environment condition-specific artificial intelligence learning models by training the performance factor target information and performance factor current state information collected based on external environmental conditions of different predetermined temperatures in association with pre-executed air conditioning control, and the control values matching the performance factor target information and performance factor current state information, using a predetermined AI algorithm.

9. The artificial intelligence air conditioning control method using interpolation of claim 8, wherein the learning processing step S310 comprises setting intervals for the collected performance factor target information associated with pre-executed air conditioning control within predetermined ranges and establishing a midpoint or a specific value for each interval as representative target information; setting intervals for the collected performance factor current state information associated with pre-executed air conditioning control within predetermined ranges and establishing a midpoint or a specific value for each interval as the representative state information; generating training data by matching the set representative target information and representative state information and control values corresponding to the representative target information and state information; and
performing the training process of the training data using the predetermined AI algorithm, based on different predetermined temperature values of the external environmental conditions.

10. The artificial intelligence air conditioning control method using interpolation of claim 9, wherein the AI control step S300 comprises determining an interval corresponding to the performance factor target information acquired at the target input step S100 and an interval corresponding to the performance factor current state information acquired at the state input step S200 by reflecting the ranges set at the learning processing step S310, and outputting the initial control values by applying specific result information to each learning model.
